(19) United States
(12) Patent Application Publication
(10) Pub. No.: US 2026/0208864 A1
(43) Pub. Date: Jul. 23, 2026

(54) Hydrogen Fueled Dual Fuselage Aircraft

(71) Applicant: Joby Aero, Inc., Santa Cruz, CA (US)

(72) Inventors: Gregor Veble Mikic, Santa Cruz, CA (US); JoeBen Bevirt, Santa Cruz, CA (US)

(21) Appl. No.: 19/347,549

(22) Filed: Oct. 1, 2025

Related U.S. Application Data
(60) Provisional application No. 63/702,157, filed on Oct. 2, 2024.

(51) Int. Cl. B64C 39/04; B64C 3/14; B64D 27/34; B64D 27/355; B64D 37/04; B64D 37/30; F17C 1/00

(52) U.S. Cl. CPC B64C 39/04; B64C 3/14; B64D 27/34; B64D 27/355; B64D 37/04; B64D 37/30; F17C 1/00; F17C 2221/012; F17C 2270/0189

(57) ABSTRACT

An electrically powered aircraft powered by hydrogen fuel cells. The aircraft may have a split, or dual, fuselage with a multi-element wing joining the fuselages. The multi-element wing may have an upper wing element and a lower wing element with internal propulsion units, such as internal ducted fans. A control wing element may be located below the upper wing element and above, and rearward of, the lower wing element. The control wing element may be articulated to provide for aircraft attitude control. The hydrogen fuel and the fuel cell systems may reside in one of the fuselages of the dual fuselage aircraft, while the pilots and passengers may reside in the other of the fuselages.

### CROSS-REFERENCE TO RELATED APPLICATIONS

This application claims priority to U.S. Patent Application 63/702,157 to Mikic et al., filed Oct. 2, 2024, which is hereby incorporated by reference in its entirety.

### FIELD OF THE INVENTION

This invention relates to aerial vehicles, including an aerial vehicle with hydrogen fueled electric propulsion.

### BRIEF DESCRIPTION OF THE DRAWINGS

FIG. 1 is a front raised perspective view of a dual fuselage aircraft according to some embodiments of the present invention.

FIG. 2 is a front lowered perspective view of a dual fuselage aircraft according to some embodiments of the present invention.

FIG. 3 is a top view of a dual fuselage aircraft according to some embodiments of the present invention.

FIG. 4 is a raised front view of a dual fuselage aircraft according to some embodiments of the present invention.

FIG. 5 is a front perspective view of a multi-element lifting system according to some embodiments of the present invention.

FIG. 6 is a lower perspective view of a multi-element lifting system according to some embodiments of the present invention.

FIG. 7 is side cutaway view of a multi-element lifting system according to some embodiments of the present invention.

FIG. 8 is upper perspective view of a multi-element lifting system according to some embodiments of the present invention.

FIG. 9 is a front view of a multi-element lifting system illustrating internal fans according to some embodiments of the present invention.

FIG. 10 is upper rear perspective view of a multi-element lifting system according to some embodiments of the present invention.

FIG. 11 is front perspective view of a multi-element lifting system according to some embodiments of the present invention.

FIG. 12 is side cutaway view of a multi-element lifting system according to some embodiments of the present invention.

FIG. 13 is a rear raised perspective view of a multi-element lifting system according to some embodiments of the present invention.

FIG. 14 is a cutaway view of internal ducting and a power unit according to some embodiments of the present invention.

FIG. 15 is a front perspective view of internal ducting according to some embodiments of the present invention.

FIG. 16 is a top view of a dual fuselage aircraft in an oblique configuration according to some embodiments of the present invention.

FIG. 17 is a top view of a dual fuselage aircraft in another configuration according to some embodiments of the present invention.

FIG. 18 is a top view of a dual fuselage aircraft in another configuration according to some embodiments of the present invention.

FIG. 19 is a partial cross-sectional view of a multi-element lifting system according to some embodiments of the present invention.

FIG. 20 is a partial cross-sectional view of a multi-element lifting system according to some embodiments of the present invention.

### SUMMARY

An electrically powered aircraft powered by hydrogen fuel cell. The aircraft may have a split, or dual, fuselage with a multi-element wing joining the fuselages. The multi-element wing may have an upper wing element and a lower wing element with internal propulsion units, such as internal ducted fans. A control wing element may be located below the upper wing element and above, and rearward of, the lower wing element. The control wing element may be articulated to provide for aircraft attitude control. The hydrogen fuel and the fuel cell systems may reside in one of the fuselages of the dual fuselage aircraft, while the pilots and passengers may reside in the other of the fuselages.

### DETAILED DESCRIPTION

Liquid hydrogen can provide a suitable means for storing and transporting energy for use in aviation, it can be manufactured with high efficiency from distributed renewable sources, and, with the highest energy density of all potential aviation fuels, it is likely the best solution for long range flight. Proton Exchanger Membrane Fuel Cells (PEMFC) have a lot of advantages for aviation applications. They have high efficiencies and high power to weight ratios.

In some embodiments of the present invention, an aerial vehicle uses a combined wing and integrated propulsion system. The wings have upper and lower elements with thrust units residing below the upper wing element and above the lower wing element. The multi-element wing further comprises a control wing element which resides behind the thrust unit and is adapted to be controllable into different positions. The control wing element provides significant lift in a forward flight configuration, although separate from the upper and lower wing elements. In some aspects, a control wing element with a different configuration may be used.

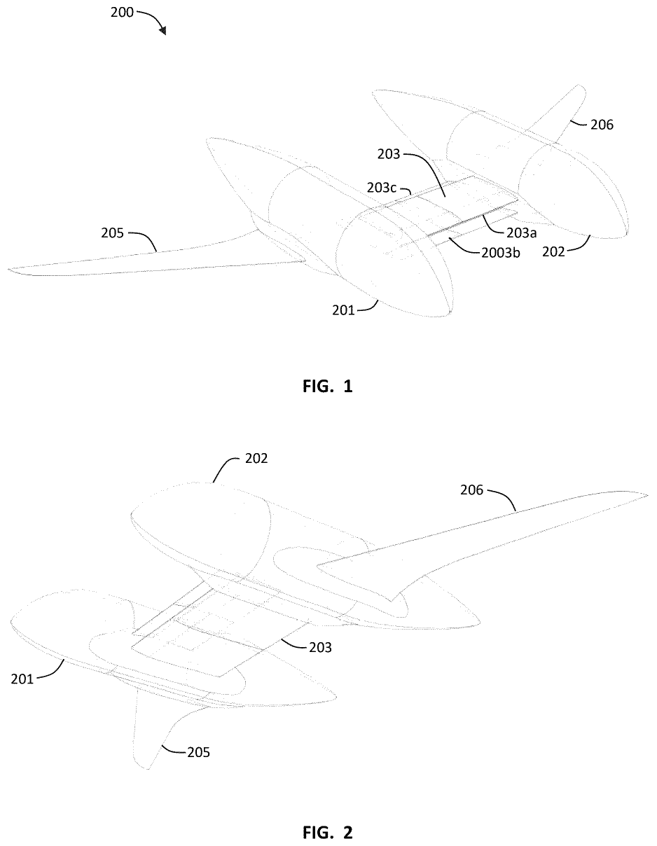

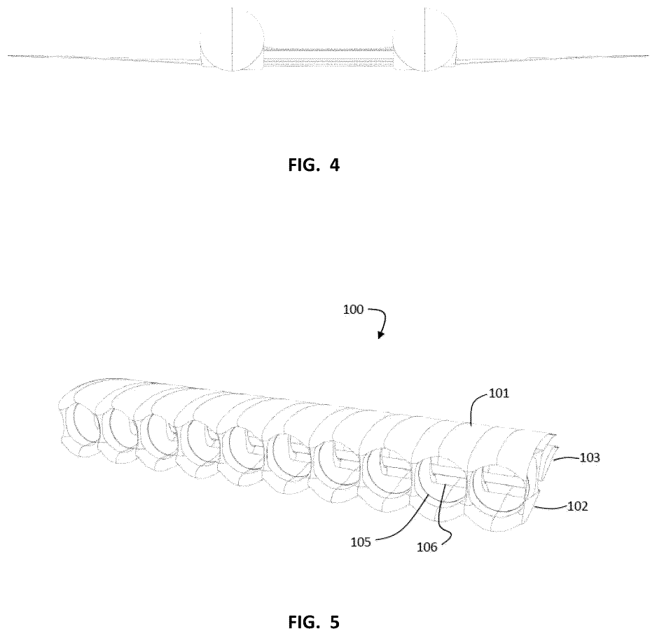

For ease of maintenance, and for possible safety advantages, it may be desirable to separate the hydrogen fuel reservoir(s) from the passenger cabin. In some embodiments of the present invention, as seen if FIGS. 1-4, a dual, or split, fuselage aircraft achieves this separation by locating the hydrogen fuel reservoir(s) in one of the two fuselages in a dual, or split, fuselage configuration. In some aspects, all to the hydrogen fueled power system, including fuel cells, are located in one of the fuselages, while the passenger cabin is located in the other fuselage. A dual fuselage aircraft 200 may have a left side fuselage 202 and a right side fuselage 201. A multi-element lifting system 203 is coupled to the left side fuselage 202 on a left end and coupled to the right side fuselage 201 on a right end. The multi-element lifting system 203 may also be viewed as a wing, but in some embodiments of the present invention the multi-element lifting system 203 may have an upper wing element 203a, a lower wing element 203b, and a control wing element 203c, with internal ducted fan units with electric motors residing between the upper wing element and the lower wing element. The internal ducted fan units are omitted in FIGS. 1-4 but are illustrated in later Figures, for example.

A left wing 206, or first outboard wing, is coupled to the outboard side of the left side fuselage, and a right wing 205, or second outboard wing, is coupled to the outboard side of the right side fuselage. In an illustrative embodiment, the distance between the fuselage centerlines is 18 m and the overall span of the aircraft 200 is 60 m. Although not seen in FIGS. 1-4, it is expected that both the right side fuselage 201 and the left side fuselage 202 would have vertical stabilizers. The vertical stabilizers may include rudders in some aspects. In some aspects the aircraft may also have a horizontal stabilizer at the rear of the right side fuselage 201 and the left side fuselage 202.

As discussed further below, the control element wing(s) 203c may be used to provide some vertical thrust so that the aircraft 200 may be able to take off in a shorter distance than if no vertical thrust was provided by the fan units.

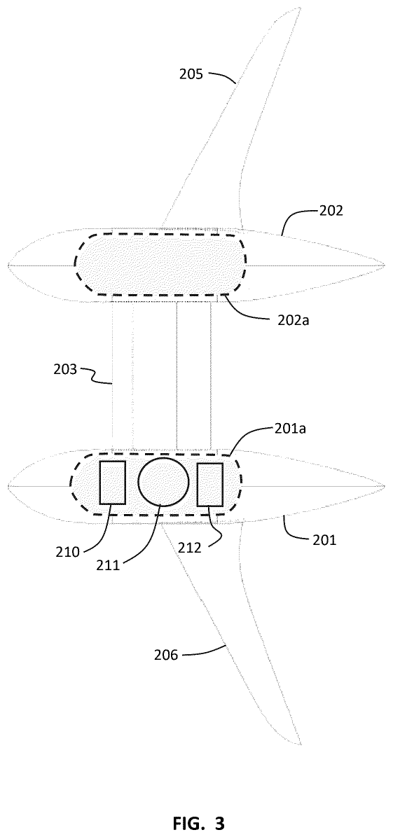

FIG. 3 illustrates a top view of the dual fuselage aircraft 200 with a hydrogen fuel system 201a residing in the left side fuselage 201, while a passenger and pilot compartment 202a resides within the right side fuselage 202. In some aspects, the right and left location of the hydrogen fuel system and the passenger compartment may be reversed. This separation of the hydrogen fuel system from the passenger compartment may provide advantages to the system.

The hydrogen fuel system 201a may include fuel cells 212 which function to convert chemical energy into electrical energy for supply to the propulsion system, which may be electrically powered internally ducted fan assemblies. The fuel cells may also be used to charge batteries which may reside within the aircraft. The fuel cell system may optionally include a heat transfer system that functions to transfer heat to or from various components of the aircraft, for example by circulating a working fluid within a fuel cell to remove heat generated during operation, to provide heat for evaporation of liquid hydrogen from the liquid hydrogen tank, or to remove heat from other heat-generating components within the aircraft. One or more hydrogen tanks 211 may be used to store fuel for the fuel cells. In some aspects, the hydrogen tank 211 may be co-located at the center of gravity of the aerial vehicle to minimize center of gravity changes as the fuel is used. Power system electronics 210 may reside in the left side fuselage and coordinate the transfer of power from the fuel cells to the thrust units in the center wing.

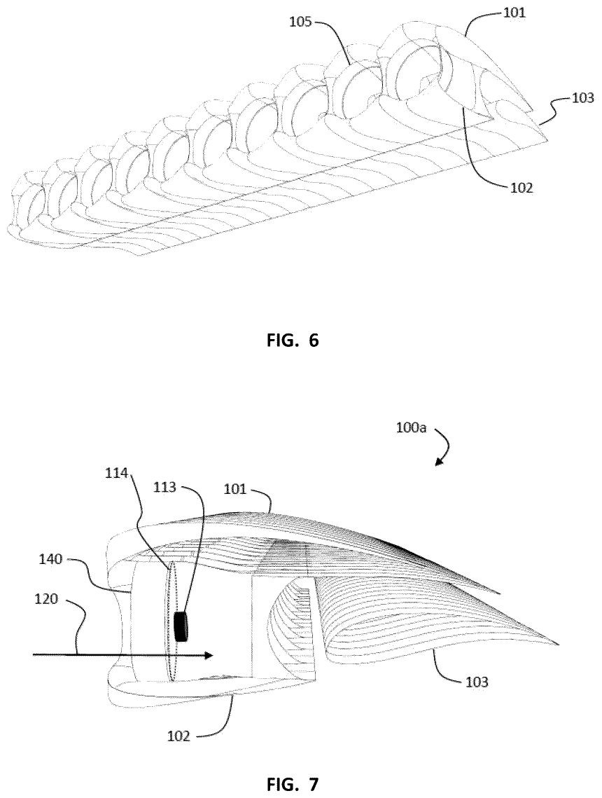

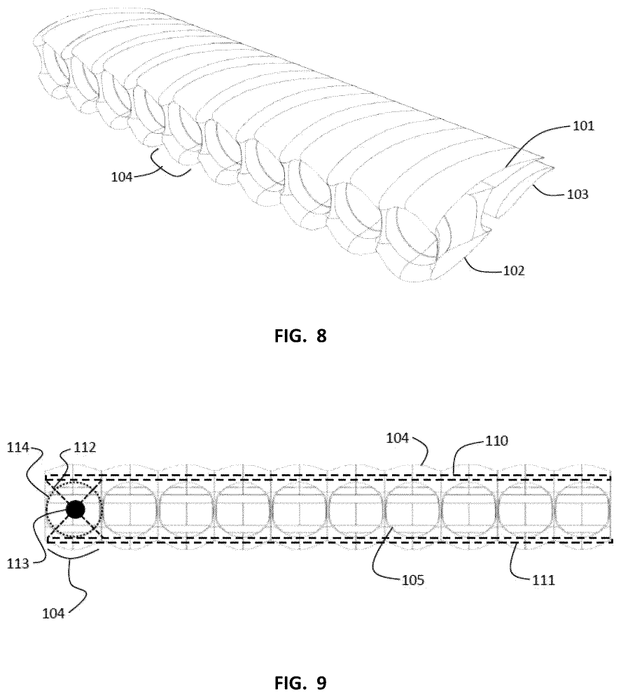

In some embodiments of the present invention, as seen in FIGS. 5-10, a multi-element lifting system with integrated propulsion 100 utilizes an upper wing element and a lower wing element with thrust units below the upper wing element and above the lower wing element. In some aspects, the thrust units are internal ducted fan units with electric motors. The multi-element lifting system 100 comprises an upper wing element 101 and a lower wing element 102. A control wing element 103 may reside rearward of the thrust elements below the upper wing element 101. In some aspects, the control wing element may have different configurations. The multi-element lifting system 100 can be viewed as comprising a plurality of side by side wing segments 104, each of which have front opening 105, which may be circular in some aspects.

As seen in FIG. 9, a wing segment 104 may contain a motor 113 which drives a thrust unit, which may be an internal ducted fan assembly 140 with a disc plane 114. In some aspects, the ducted fan assembly stator may have stator vanes. In some aspects, the vanes are a plurality of radial vanes. In some aspects, the vanes are radial vanes with one or more circular vanes. In an exemplary embodiment, the fan diameter may be 0.3 meters. The multi-element lifting system may have an upper spar 110 and a lower spar 111 which traverse through the wing segments 104 to provide structural strength and rigidity to the lifting system. The motor 113 may be mounted to braces, or cross-braces 112, which may be structurally coupled to the spars 110, 111. In some aspects, the braces may be included to function as the stator vanes. Although illustrated in FIG. 9 with just one wing segment 104 containing a motor 113 and disc plane 114, it is to be understood that each of the wing segments 104 would have a thrust unit.

As seen in cross-sectional side view in FIG. 7, airflow 120 through the front opening 105 will flow below the upper wing element 101 and above the lower wing element 102. The motor 113 rotates a thrust element, with the disc plane 114 rearward of the front opening 105. In some aspects, the ducted fan assembly stator may have stator vanes. In some aspects, the vanes are a plurality of radial vanes rearward of the thrust element. In some aspects, the vanes are radial vanes with one or more circular vanes. The front opening 105 may be substantially circular, while the rear exit area may be substantially rectangular, or square. A control wing element 103 resides rearward of the thrust elements below the upper wing element 101. The control wing element 103 is a detached element which provides significant lift in forward flight. The control wing element 103 helps to regulate the airflow through the system, may act as a flow restrictor for the velocity through the thrust element, which also will reduce the drag around the mechanisms, as well as the drag of the internal walls of the airflow chamber, and the stator and stator vanes, and which will support and articulate the control wing element. Although described herein as a multi-element lifting system with three wing elements, the system could be viewed as a wing with integrated propulsion and internal airflow, with a trailing control element. In some aspects, a control wing element with a different configuration may be used.

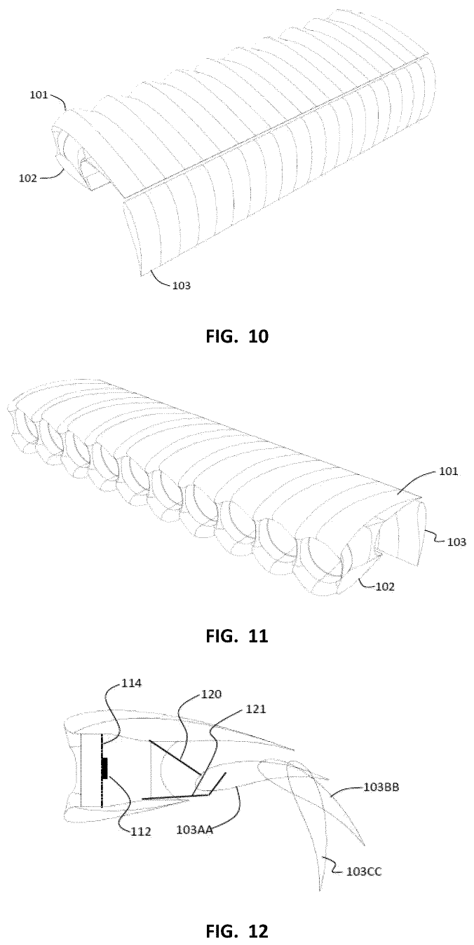

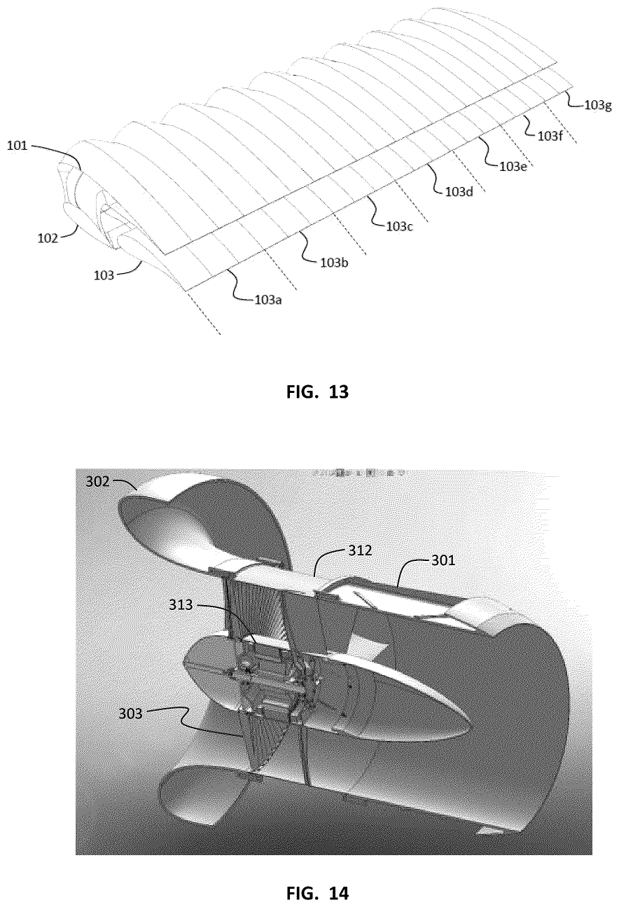

In some aspects, the control wing element is a singular element which traverses the length of the wing, and all of the control wing element is positioned uniformly along the length of the wing. In some aspects, there is a separate control wing element segments for each of the thrust elements, and each control wing element segment is individually controllable. In an illustrative embodiment, as seen in FIG. 10, each control wing element segment traverses up to three thrust units, with each of these control wing element segments 103a, 103b, 103c, 103d, 103e, 103f, 103g individually controllable to a desired angular position. The thrust units together with control wing segment deflections allow for variation of both the magnitude as well as direction of thrust in all flight regimes. Furthermore, even in absence of thrust, in forward flight, the movement of the control wing segment affects the lift on that wing section in the way a traditional control surface on an aircraft does. This allows for aircraft to have full control of all angular axes of flight without additional control elements. In some aspects, the aerial vehicle does not have controllable control elements other than the control wing segments.

The control wing element 103 may extend rearward of the upper wing element in the forward flight, as seen in in FIG. 10, for example. A full characterization of sectional duct aerodynamic lift and wind aligned drag/thrust as a function of forward speed, control wing segment deflection, fan pressure (as it relates to dynamic pressure), local angle of attack can be generated using computational fluid dynamics or wind tunnel tests. Such analyses can also be performed for the complete vehicle. Using that information, control strategies as well as overall aircraft trim strategies in all regimes of flight can be optimized based on the specific characteristics of the system. Those strategies can be similar to the ones described above, or can be different.

As seen in a cross-sectional side view in FIG. 12, the control wing element may reside in a forward flight position 103a, transition through an intermediate position 103b, and continue out to a vertical take-off and landing position 103c. A set of mechanized articulating linkages 120, 121 may be used to deploy the control wing element to the different positions. In an illustrative embodiment, the vertical distance of the air passage rearward of the thrust element in a wing segment may be approximately the same as the horizontal distance from the rearward end of the lower wing segment to the control wing segment while in the vertical configuration 103c.

FIGS. 10-11 illustrate the multi-element lifting system 100 in a vertical take-off and landing configuration 100c according to some embodiments of the present invention. In this configuration, the airflow from the thrust elements is deflected downwards to provide vertical thrust. The upper wing element 101 resides above the lower wing element 102. Airflow into the front opening 105 of the wing segment 104 travels through the ducted fan assembly 140 and is then deflected by the control element 103. The control element 103 may partially deflect the thrust downwards, which allows for a shorter take-off of the aerial vehicle.

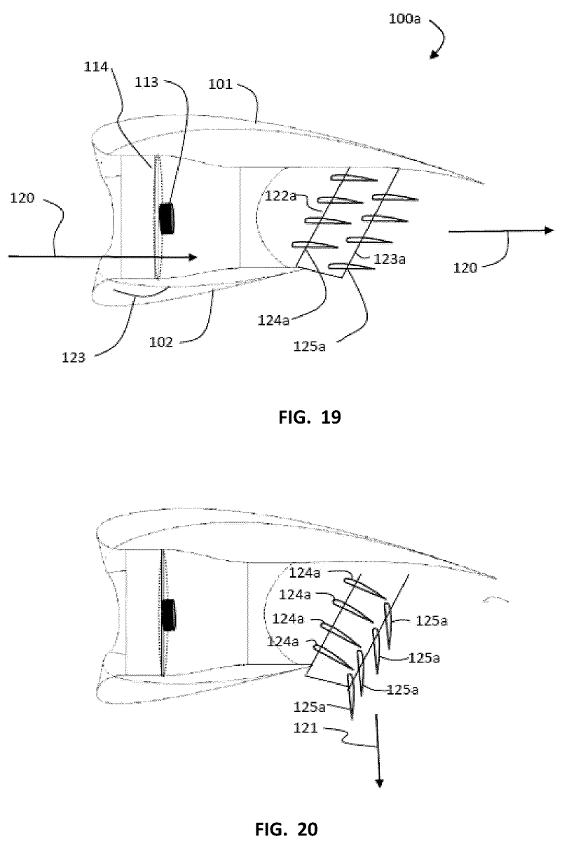

In another embodiment of the present invention, as seen in FIGS. 19 and 20 in cross-sectional side view, airflow 120 through the front opening 105 will flow below the upper wing element 101 and above the lower wing element 102. The motor 113 rotates a thrust element, such as a ducted fan, with the disc plane 114 rearward of the front opening 105. In some aspects, the ducted fan assembly stator may have stator vanes. In some aspects, the vanes are a plurality of radial vanes rearward of the thrust element. In some aspects, the vanes are radial vanes with one or more circular vanes. The front opening 105 may be substantially circular, while the rear exit area may be substantially rectangular, or square. A plurality of forward control elements 122a resides rearward of the thrust elements below the upper wing element 101. The forward control elements 122a may be coupled to the wing assembly with a support 124a. A plurality of rearward control elements 123a reside rearward of the forward control elements 122a. The rearward control elements 123a may be coupled to the wing assembly with a support 125a. The supports 124a, 125a may include deployment mechanisms configured to articulate the control elements. The control elements are detached elements which may provide lift in forward flight. The control elements help to regulate the airflow through the system, may act as a flow restrictor for the velocity through the thrust element, which also will reduce the drag around the mechanisms, as well as the drag of the internal walls of the airflow chamber, and the stator and stator vanes, and which may support and articulate the control wing elements. The control elements may be coupled to the upper wing element 101 and/or the upper spar 110, with one or more deployment mechanisms.

FIG. 19 illustrates the wing 100a in a forward flight configuration, with the forward control elements 122a, 123a in a substantially horizontal configuration, with the thrust in a rear facing horizontal direction 120. FIG. 20 illustrates the wing 100a in a hover, or vertical thrust, configuration, with the forward control elements tilted. The forward control elements 122a are partially tilted, with the rearward control elements fully tilted, with the thrust in a substantially downward facing vertical direction 121. The forward control elements 122a are configured to feed a paired rearward control element 123a to couple together to route the air flow.

In some aspects, the control elements are continuous elements which traverse the length of the wing, and all of the control elements are positioned uniformly along the length of the wing. In some aspects, there are separate control element segments for each of the thrust elements, and each control wing element segment is individually controllable. In some aspects each control element segment traverses up to three thrust units, with each of these control element segments individually controllable to a desired angular position. The thrust units together with control segment deflections allow for variation of both the magnitude as well as direction of thrust in all flight regimes. In some aspects, there may be segments 104 coupled together to allow for horizontal, forward, displacement and which then also have their control element segments 103 similarly coupled together. Furthermore, even in absence of thrust, in forward flight, the movement of the control segments affects the lift on that wing section in the way a traditional control surface on an aircraft does. This allows for aircraft to have full control of all angular axes of flight without additional control elements. In some aspects, the aerial vehicle does not have controllable control elements other than the control segments.

In hover, changing the angle of the control segments will change the direction of thrust. This allows for yaw control in hover. Differential thrust along the longitudinal axis allows for pitch control, differential thrust along the lateral axis for roll control. Collective movement of the control segments will create a forward/rearward thrust that allows the aircraft to accelerate/decelerate, and this can be combined with overall aircraft pitching motion close to hover to achieve acceleration/deceleration.

In forward flight, differential control segment deflection along the longitudinal axis, such as with a swept wing or forward and rearward wings, creates a longitudinal distribution of lift that gives pitch control. Differential control segment deflection along the lateral axes creates a lift distribution gives roll control. Thrust distribution along the lateral axis gives yaw control. For regimes of flight between hover and forward flight, a blend of the above strategies is effective.

In some aspects, the control elements may reside in a forward flight position, transition through an intermediate position, and continue out to a vertical take-off and landing position. A set of mechanized articulating linkages may be used to deploy the control elements to the different positions.

FIG. 14 illustrates in cross-section a thrust unit which may be used in the aircraft, which can be an internal ducted fan. The overall tube may have a front duct ring 302, a center support ring 312, and a rear duct section 301. The center support ring 312 may provide mounting support for an electric motor 313 configured to rotate a thrust fan 303. The center support ring 312 may include a plurality of vanes which provide support for the mounting of the motor 313.

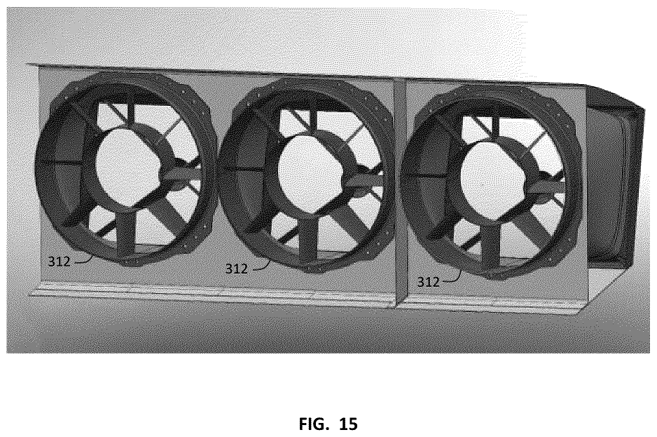

FIG. 15 illustrates a plurality of center support rings 312 in a side-by-side configuration as they may be seen in a multi-element lifting system in the aircraft 200. Other components are omitted for clarity.

In forward flight, differential control wing segment deflection along the longitudinal axis creates a longitudinal distribution of lift that gives pitch control. Differential control wing segment deflection along the lateral axes creates a lift distribution gives roll control. Thrust distribution along the lateral axis gives yaw control. For regimes of flight between hover and forward flight, a blend of the above strategies is effective.

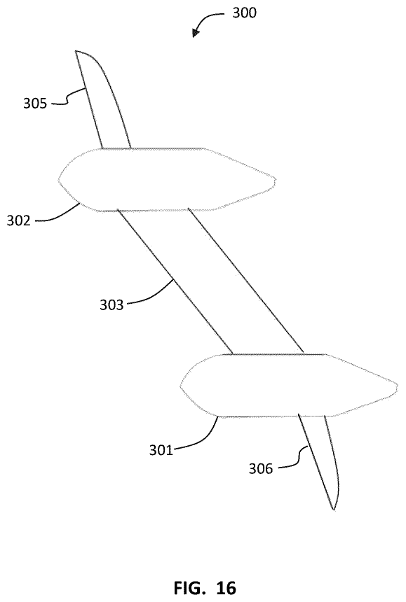

FIG. 16 illustrates an oblique wing dual fuselage aircraft 300 according to some embodiments of the present invention. The oblique wing dual fuselage aircraft 300 may have a left side fuselage 301 and a right side fuselage 302. A multi-element lifting system 303 is coupled to the left side fuselage 301 on a left end and coupled to the right side fuselage 302 on a right end. The internal ducted fan units within the center wing, or multi-element lifting system 303, may be configured such that they align with the forward flight direction of the aircraft, and thus are not perpendicular to the leading edge of the wing. A left outboard wing 305 is coupled to the outboard side of the left side fuselage, and a right outboard wing 306 is coupled to the outboard side of the right side fuselage. In some aspects, the outboard wing on the forward fuselage may be forward swept, and the outboard wing on the trailing fuselage may be rearward swept.

Vertical stabilizers may be coupled to the rearward ends of the fuselages. The vertical stabilizers may include rudders in some aspects. A hydrogen fuel system may reside in the left side fuselage, while a passenger and pilot compartment resides within the right side fuselage. In some aspects, the right and left location of the hydrogen fuel system and the passenger compartment may be reversed. This separation of the hydrogen fuel system from the passenger compartment may provide advantages to the system.

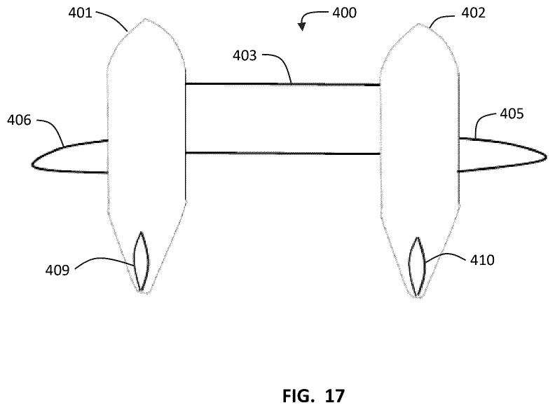

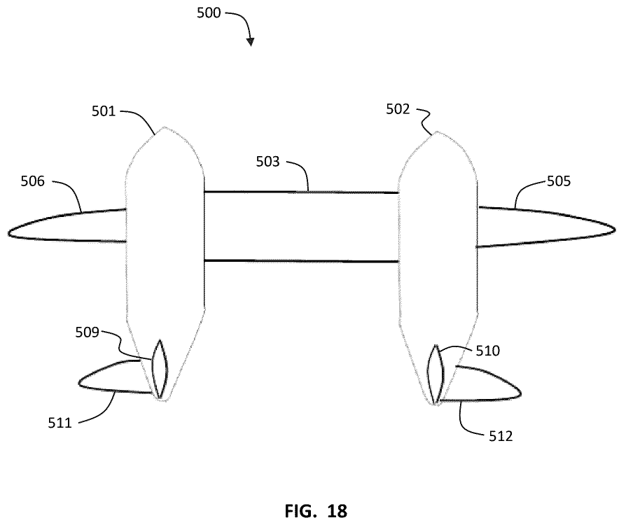

In some embodiments of the present invention, as seen in FIG. 17, a dual fuselage aircraft 400 may have a left side fuselage 401 and a right side fuselage 402. A multi-element lifting system 403 is coupled to the left side fuselage 401 on a left end and coupled to the right side fuselage 402 on a right end. A small left side wing 406 is coupled to the left side fuselage 401, and a small left side wing 405 is coupled to the right side fuselage 402. Vertical stabilizers 409, 410 are coupled to the rearward ends of the fuselages. The vertical stabilizers 409, 410 may include rudders in some aspects. A multi-element lifting system with integrated propulsion utilizes an upper wing element and a lower wing element with thrust units below the upper wing element and above the lower wing element. In some aspects, the thrust units are internal ducted fan units with electric motors. The multi-element lifting system 403 comprises an upper wing element and a lower wing element. A control wing element may reside rearward of the thrust elements below the upper wing element. In some aspects, the control wing element may have different configurations. The multi-element lifting system can be viewed as comprising a plurality of side by side wing segments, each of which have front opening, which may be circular in some aspects.

A hydrogen fuel system may reside in the left side fuselage, while a passenger and pilot compartment resides within the right side fuselage. In some aspects, the right and left location of the hydrogen fuel system and the passenger compartment may be reversed. This separation of the hydrogen fuel system from the passenger compartment may provide advantages to the system.

In some embodiments of the present invention, as seen in FIG. 18, a dual fuselage aircraft 500 may have a left side fuselage 501 and a right side fuselage 502. A multi-element lifting system 503 is coupled to the left side fuselage 501 on a left end and coupled to the right side fuselage 502 on a right end. A multi-element lifting system with integrated propulsion utilizes an upper wing element and a lower wing element with thrust units below the upper wing element and above the lower wing element. In some aspects, the thrust units are internal ducted fan units with electric motors. The multi-element lifting system 503 comprises an upper wing element and a lower wing element. A control wing element may reside rearward of the thrust elements below the upper wing element. In some aspects, the control wing element may have different configurations. The multi-element lifting system can be viewed as comprising a plurality of side by side wing segments, each of which have front opening, which may be circular in some aspects. A right side wing 505 is coupled to the outboard side of the right side fuselage 502. A left side wing 506 is coupled to the outboard side of the left side fuselage 501. A left side vertical stabilizer 509 is coupled to a rear end of the left side fuselage 501. A left side horizontal stabilizer 511 may extend only outboard of the left side fuselage 501 to avoid placement in the area behind the thrust units. A left side vertical stabilizer 509 is coupled to a rear end of the left side fuselage 501. A right side horizontal stabilizer 510 may extend only outboard of the left side fuselage 502 to avoid placement in the area behind the thrust units.

A hydrogen fuel system may in the left side fuselage 501, while a passenger and pilot compartment resides within the right side fuselage. In some aspects, the right and left location of the hydrogen fuel system and the passenger compartment may be reversed. This separation of the hydrogen fuel system from the passenger compartment may provide advantages to the system.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A hydrogen powered dual fuselage aircraft, said aircraft comprising:
a first fuselage,
a second fuselage,
a central wing, said central wing coupled to said first fuselage on a first end, said central wing coupled to said second fuselage on a second end;
a hydrogen fuel system, said hydrogen fuel system residing in said first fuselage; and
a passenger compartment, said passenger compartment residing in said second fuselage.

2. The hydrogen powered dual fuselage aircraft of claim 1 wherein said central wing comprises:
an upper wing element;
a lower wing element, said lower element residing below said upper wing element;
a plurality of airflow segments, said airflow segments coupled to said upper wing element on an upper end, said airflow segments coupled to said lower wing segment on a lower end;
a plurality of thrust units, said thrust units residing in said airflow segments; and
one or more control wing segments, said control wing segments residing below said upper wing element and rearward of said lower wing element.

3. The hydrogen powered dual fuselage aircraft of claim 1 further comprising:
one or more forward control segments, said forward control segments residing below said upper wing element and rearward of said lower wing element; and
one or more rearward control segments, said rearward control segments residing below said upper wing element and rearward of said lower wing element.

4. The hydrogen powered dual fuselage aircraft of claim 1 wherein said hydrogen fuel system comprises:
a hydrogen fuel tank; and
a fuel cell.

5. The hydrogen powered dual fuselage aircraft of claim 2 wherein said hydrogen fuel system comprises:
a hydrogen fuel tank; and
a fuel cell.

6. The hydrogen powered dual fuselage aircraft of claim 3 wherein said hydrogen fuel system comprises:
a hydrogen fuel tank; and
a fuel cell.

7. The hydrogen powered dual fuselage aircraft of claim 1 further comprising:
a first outboard wing coupled to an outboard side of said first fuselage; and
a second outboard wing coupled to an outboard side of said second side fuselage.

8. The hydrogen powered dual fuselage aircraft of claim 2 further comprising:
a first outboard wing coupled to an outboard side of said first fuselage; and
a second outboard wing coupled to an outboard side of said second fuselage.

9. The hydrogen powered dual fuselage aircraft of claim 3 further comprising:
a first outboard wing coupled to an outboard side of said first fuselage; and
a second outboard wing coupled to an outboard side of said second fuselage.

10. The hydrogen powered dual fuselage aircraft of claim 7 wherein said first outboard wing and said second outboard wing are rearward swept wings.

11. The hydrogen powered dual fuselage aircraft of claim 8 wherein said first outboard wing and said second outboard wing are rearward swept wings.

12. The hydrogen powered dual fuselage aircraft of claim 9 wherein said first outboard wing and said second outboard wing are rearward swept wings.

13. The hydrogen powered dual fuselage aircraft of claim 7 wherein said central wing is an oblique wing, and wherein one of said first fuselage and said second fuselage is forward of the other in a flight configuration.

14. The hydrogen powered dual fuselage aircraft of claim 8 wherein said central wing is an oblique wing, and wherein one of said first fuselage and said second fuselage is forward of the other in a flight configuration.

15. The hydrogen powered dual fuselage aircraft of claim 9 wherein said central wing is an oblique wing, and wherein one of said first fuselage and said second fuselage is forward of the other in a flight configuration.

16. The hydrogen powered aircraft of claim 13 wherein an outboard wing of the forward fuselage is forward swept, and wherein an outboard wing of the rearward fuselage is rearward swept.

17. The hydrogen powered aircraft of claim 14 wherein an outboard wing of the forward fuselage is forward swept, and wherein an outboard wing of the rearward fuselage is rearward swept.

18. The hydrogen powered aircraft of claim 15 wherein an outboard wing of the forward fuselage is forward swept, and wherein an outboard wing of the rearward fuselage is rearward swept.
